(19) United States
(12) Patent Application Publication
(10) Pub. No.: US 2025/0383685 A1
(43) Pub. Date: Dec. 18, 2025

(54) INTERFACE CONVERSION CIRCUIT, METHOD FOR PROCESSING SIGNALS, AND ELECTRONIC DEVICE

(71) Applicants: Haining ESWIN Computing Technology Co., Ltd., Haining (CN); Beijing ESWIN Computing Technology Co., Ltd., Beijing (CN)

(72) Inventors: Hang JIANG, Beijing (CN); Li HUA, Beijing (CN)

(21) Appl. No.: 18/965,191

(22) Filed: Dec. 2, 2024

(30) Foreign Application Priority Data
Jun. 18, 2024 (CN) 202410789335.X

(51) Int. Cl. G06F 1/12

(52) U.S. Cl. CPC G06F 1/12

(57) ABSTRACT

An interface conversion circuit, a method for processing signals, and a device are provided. The interface conversion circuit interface includes: a storage unit, configured to write a first image signal output by a multimedia module interface according to a write address signal, read the first image signal according to a read address signal, and output the first image signal; a mapping unit, configured to reorder pixel components of the received first image signal to obtain a second image signal meeting the display requirement of a display module interface, and transmitting the second image signal to the display module interface; and a deviation detection unit, configured to acquire the write address signal and the read address signal and adjust a read timing and a write timing of the storage unit according to the write address signal and the read address signal.

This application is based on and claims priority to Chinese Patent Application No. 202410789335.X filed on June 18, 2024, and entitled "INTERFACE CONVERSION CIRCUIT, AND METHOD, DEVICE AND CHIP FOR PROCESSING SIGNALS", and the disclosure of which is herein incorporated by reference in its entirety.

### TECHNICAL FIELD

The embodiments of the present disclosure relate to the field of electronic technology, and in particular, to an interface conversion circuit, a method for processing signals, and an electronic device.

### BACKGROUND

In the field of electronic technology, a high definition multimedia interface (HDMI) is a fully digital video and audio transmission interface for transmitting multimedia signals such as audio signals, video signals, or image signals. In some cases, the HDMI may transmit an image signal to a display module, through which an image is displayed. There is a mismatch of timings between the HDMI and the display module in some cases. For example, the timing of the image signal output by the HDMI is 4 pixels per clock (clk), while the timing of the image signal required by the display module is 2 pixels per clk. Therefore, an interface conversion circuit is urgently needed to solve the mismatch between the timings of the HDMI and the display module.

### SUMMARY

The present disclosure provides an interface conversion circuit, a method for processing signals, and an electronic device. The technical solutions are as follows.

In one aspect, the present disclosure provides an interface conversion circuit. The interface conversion circuit includes a storage unit, a mapping unit, and a deviation detection unit; the storage unit is connected to a multimedia module interface, the mapping unit, and the deviation detection unit, and the mapping unit is further connected to a display module interface;

the storage unit is configured to receive a first image signal output by the multimedia module interface, write the first image signal according to a write address signal, read the first image signal according to a read address signal, and output the first image signal that is read to the mapping unit;

the mapping unit is configured to receive the first image signal, reorder pixel components of the first image signal to obtain a second image signal meeting a display requirement of the display module interface, and transmit the second image signal to the display module interface; and

the deviation detection unit is configured to acquire the write address signal and the read address signal, determine a first difference value between the write address signal and the read address signal, and adjust a read timing and a write timing of the storage unit according to the first difference value.

In some embodiments, the interface conversion circuit further includes a write control unit, and the storage unit is connected to the multimedia module interface via the write control unit;

a clock domain of the write control unit is consistent with a clock domain of the multimedia module interface;

the write control unit is configured to receive the first image signal and an image enable signal output by the multimedia module interface, determine the write address signal and a write enable signal according to the image enable signal, and output the write address signal, the write enable signal, and the first image signal to the storage unit;

the storage unit is configured to receive the write address signal, the write enable signal, and the first image signal and write the first image signal according to the write address signal in the case that the write enable signal is valid.

In some embodiments, the interface conversion circuit further includes a read control unit, and the storage unit is configured to be connected to the mapping unit via the read control unit;

a clock domain of the read control unit is consistent with a clock domain of the display module interface;

the read control unit is configured to acquire a clock domain enable signal of the interface conversion circuit and thereby obtain a read enable signal, count through a clock of the display module interface in the case that the read enable signal is valid, determine the read address signal according to a counting result, and output the read enable signal and the read address signal to the storage unit;

the storage unit is configured to receive the read enable signal and the read address signal, read the first image signal according to the read address signal in the case that the read enable signal is valid, and transmit the first image signal to the read control unit;

the read control unit is configured to receive the first image signal and transmit the first image signal to the mapping unit.

In some embodiments, a clock domain corresponding to the read address signal is consistent with a clock domain of the display module interface, and the deviation detection unit is configured to detect the clock domain of the display module interface according to the first difference value and adjust the clock domain of the display module interface according to a detection result.

In some embodiments, the deviation detection unit is configured to: determine that the detection result indicates that the clock domain of the display module interface is slow in the case that the first difference value is not less than a unit depth of the storage unit; or

determine that the detection result indicates that the clock domain of the display module interface is fast in the case that the first difference value is less than a first numerical value.

In some embodiments, the interface conversion circuit further includes a synchronization unit and a clock domain conversion unit; the synchronization unit is connected to the multimedia module interface, the synchronization unit is further connected to the clock domain conversion unit, and the clock domain conversion unit is connected to the mapping unit;

the synchronization unit is configured to receive an inputting timing signal from the multimedia module interface and transmit the inputting timing signal to the clock domain conversion unit, wherein the inputting timing signal is used for controlling a screen parameter in a process of displaying an image, the inputting timing signal is within a clock domain of the multimedia module interface, and a clock domain of the synchronization unit is consistent with the clock domain of the multimedia module interface;

the clock domain conversion unit is configured to receive the inputting timing signal, convert the inputting timing signal to obtain an outputting timing signal within a clock domain of the display module interface, and transmit the outputting timing signal to the mapping unit;

the mapping unit is further configured to receive the outputting timing signal and transmit the outputting timing signal to the display module interface, wherein the outputting timing signal is used for controlling the display module interface to display an image according to the second image signal.

In some embodiments, the inputting timing signal includes a vertical synchronization signal, and the synchronization unit is further configured to control the clock domain of the synchronization unit to be synchronized with the clock domain of the multimedia module interface according to the vertical synchronization signal.

In some embodiments, the synchronization unit is configured to: enable a configuration information update signal and determine, in the case that the vertical synchronization signal is enabled, that the clock domain of the synchronization unit is synchronized with the clock domain of the multimedia module interface; or

enable the configuration information update signal, disable the configuration information update signal in the case that the vertical synchronization signal is not enabled within a reference period, and determine that the clock domain of the synchronization unit is synchronized with the clock domain of the multimedia module interface in the case that the configuration information update signal is enabled again based on the vertical synchronization signal.

In some embodiments, the clock domain conversion unit is configured to acquire a horizontal resolution signal and a register configuration parameter and convert the inputting timing signal, the register configuration parameter, and the horizontal resolution signal into the outputting timing signal, wherein the horizontal resolution signal indicates a horizontal resolution of the clock domain of the multimedia module interface.

In another aspect, a method for processing signals is provided. The method includes:

receiving a first image signal output by a multimedia module interface and writing the first image signal to a storage unit according to a write address signal;

Reading the first image signal from the storage unit according to a read address signal in the case that there is a need to read the first image signal;

reordering pixel components of the first image signal to obtain a second image signal meeting a display requirement of a display module interface and transmitting the second image signal to the display module interface; and

determining a first difference value between the write address signal and the read address signal and adjusting a read timing and a write timing of the storage unit according to the first difference value.

In some embodiments, receiving the first image signal output by the multimedia module interface and writing the first image signal to a storage unit according to the write address signal includes:

receiving the first image signal and an image enable signal output by the multimedia module interface and determining the write address signal and a write enable signal according to the image enable signal; and

writing the first image signal to a storage unit according to the write address signal in the case that the write enable signal is valid.

In some embodiments, Reading the first image signal from the storage unit according to the read address signal includes:

acquiring a clock domain enable signal and determining the clock domain enable signal as a read enable signal;

counting through a clock of the display module interface in the case that the read enable signal is valid and determining the read address signal according to a counting result; and

Reading the first image signal from the storage unit according to the read address signal.

In some embodiments, adjusting the read timing and the write timing of the storage unit according to the first difference value includes:

detecting a clock domain of the display module interface according to the first difference value; and

adjusting the clock domain of the display module interface according to a detection result.

In some embodiments, detecting the clock domain of the display module interface according to the first difference value includes:

determining that the detection result indicates that the clock domain of the display module interface is slow in the case that the first difference value is not less than a unit depth of the storage unit; or

determining that the detection result indicates that the clock domain of the display module interface is fast in the case that the first difference value is less than a first numerical value.

In some embodiments, the method further includes:

receiving an inputting timing signal from the multimedia module interface, wherein the inputting timing signal is used for controlling a screen parameter in a process of displaying an image, and the inputting timing signal is within a clock domain of the multimedia module interface;

converting the inputting timing signal to obtain an outputting timing signal, wherein the outputting timing signal is within a clock domain of the display module interface; and

transmitting the outputting timing signal to the display module interface, wherein the outputting timing signal is used for controlling the display module interface to display an image according to the second image signal.

In some embodiments, the inputting timing signal includes a vertical synchronization signal, and before receiving the inputting timing signal from the multimedia module interface, the method further includes:

synchronizing, by a synchronization unit, a clock domain of the synchronization unit with the clock domain of the multimedia module interface according to the vertical synchronization signal.

In some embodiments, synchronizing, by the synchronization unit, the clock domain of the synchronization unit with the clock domain of the multimedia module interface according to the vertical synchronization signal includes:

enabling, by the synchronization unit, a configuration information update signal and determining, in the case that the vertical synchronization signal is enabled, that the configuration information update signal is synchronized with the clock domain of the multimedia module interface; or

enabling, by the synchronization unit, the configuration information update signal, disabling the configuration information update signal in the case that the vertical synchronization signal is not enabled within a reference period, and determining that the configuration information update signal is synchronized with the clock domain of the multimedia module interface in the case that the configuration information update signal is enabled again based on the vertical synchronization signal.

In some embodiments, converting the inputting timing signal to obtain the outputting timing signal includes:

acquiring a horizontal resolution signal and a register configuration parameter, wherein the horizontal resolution signal indicates a horizontal resolution of the clock domain of the multimedia module interface; and

converting the inputting timing signal, the register configuration parameter, and the horizontal resolution signal into the outputting timing signal.

In another aspect, an electronic device is provided. The electronic device includes a multimedia module interface, an interface conversion circuit, and a display module interface; the interface conversion circuit is configured to execute the method for processing signals described above to convert a first image signal output by the multimedia module interface into a second image signal meeting a display requirement of the display module interface and transmit the second image signal to the display module interface.

### BRIEF DESCRIPTION OF THE DRAWINGS

For describing the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic structural diagram of an interface conversion circuit according to some embodiments of the present disclosure;

FIG. 2 is a structural diagram of another interface conversion circuit according to some embodiments of the present disclosure;

FIG. 3 is a schematic diagram illustrating reordering of pixel components according to some embodiments of the present disclosure;

FIG. 4 is a diagram of signal timing according to some embodiments of the present disclosure;

FIG. 5 is another diagram of signal timing according to some embodiments of the present disclosure;

FIG. 6 is a schematic diagram illustrating signal selection according to some embodiments of the present disclosure;

FIG. 7 is a schematic diagram illustrating state transition according to some embodiments of the present disclosure; and

FIG. 8 is a flow chart of a method for processing signals according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

In the field of electronic technology, more and more application scenarios involve the use of high definition multimedia interface (HDMI), through which audio signals, image signals, or video signals can be transmitted and high-resolution content is supported. In some embodiments, the HDMI is generally used for connecting devices such as a television, a projector, a game console, and a speaker power amplifier. In some embodiments, a video source device inputs a signal to a display module through the HDMI. The display module is configured to process videos, images, and the like, and is more focused on video processing. The HDMI is located at the Receive (RX) and is responsible for audio and video transmission, and signals corresponding to the audio and the video are transmitted to the display module inside the chip for processing.

In some embodiments, there is a mismatch of timings between the HDMI and the display module. For example, the HDMI supports transmitted image signals with a timing of 4 pixels per clk, while the display module supports transmitted image signals with a timing of 2 pixels per clk. This can be understood as follows: within the same time, the HDMI transmits more image signals than the display module processes, and the display module processes the image signals at a slow speed, which may cause loss of the image signals. Therefore, the HDMI performs conversion from a high pixel amount to a low pixel amount during the process of inputting the image signals to the display module. The embodiments of the present disclosure provide an interface conversion circuit, which is configured to be connected with an HDMI and a display module.

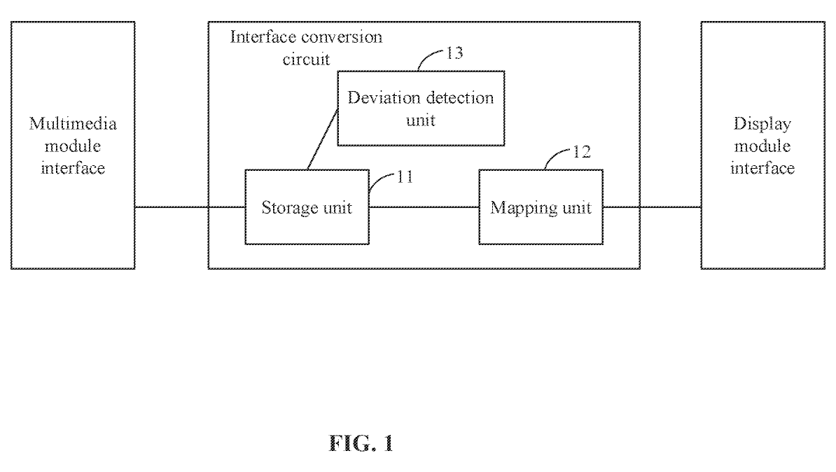

FIG. 1 is a schematic structural diagram of an interface conversion circuit according to some embodiments of the present disclosure. The interface conversion circuit in FIG. 1 includes a storage unit 11, a mapping unit 12, and a deviation detection unit 13. The storage unit 11 is connected to a multimedia module interface, the mapping unit 12, and the deviation detection unit 13, and the mapping unit 12 is connected to a display module interface. The multimedia module interface in FIG. 1 corresponds to the interface of the HDMI module of the embodiment described above and may be referred to as HDMI_SUBSYS in some cases, and the display module interface corresponds to the interface of the display module of the embodiment described above and may be referred to as DPU_SUBSYS in some cases. The display module interface refers to a wiring interface of the display module inside the chip and is not an interface for defining that the display module interface belongs to physical display.

Exemplarily, the multimedia module interface may input a first image signal to the storage unit 11, and the storage unit 11 may write the first image signal according to a write address signal after receiving the first image signal output by the multimedia module interface, and then may read the first image signal according to a read address signal and output the read-out first image signal to the mapping unit 12 in the case that a signal is to be output to the display module interface, that is, in the case that there is a need to read the first image signal.

The first image signal may be any electrical signal used for displaying an image. The image displayed may be a static image; it may also be a dynamic image, such as video, and in this case, what is displayed through the first image signal is the image of each frame of the video, and images of multiple frames are displayed sequentially through the first image signal to achieve the effect of playing the video. The first image signal may also be referred to as a video signal in the case that the image displayed by the first image signal is a single-frame image of a video.

In some embodiments, the storage unit 11 may be any unit having a storage function and may be an SRAM (static random-access memory). In some embodiments, the storage unit 11 is a pseudo dual ported SRAM. The pseudo dual ported means that there are two read/write ports, but one port is only used for reading and the other port is only used for writing. The storage unit 11 has two sets of data lines, one set is a write data line and the other set is a read data line, and two operations, i.e., reading and writing, can be performed on the storage unit 11 at the same time.

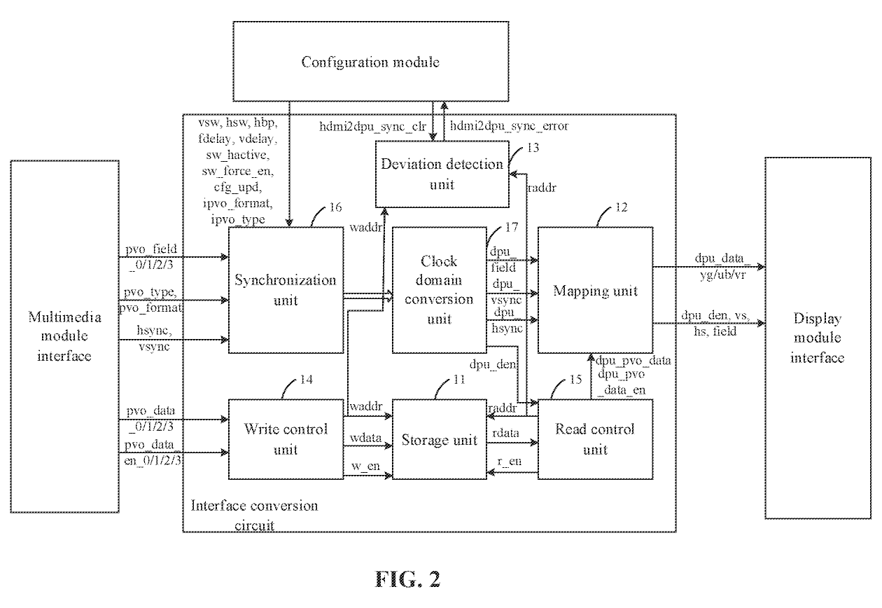

FIG. 2 is another interface conversion circuit according to some embodiments of the present disclosure. In FIG. 2, the interface conversion circuit further includes a write control unit 14, and the storage unit 11 is connected to the multimedia module interface via the write control unit 14. In some embodiments, the clock domain of the write control unit 14 is consistent with the clock domain of the multimedia module interface, and for the effect of clock domain synchronization, reference may be made to the description of metastability in the process of introducing the synchronization unit 16 in the following embodiments.

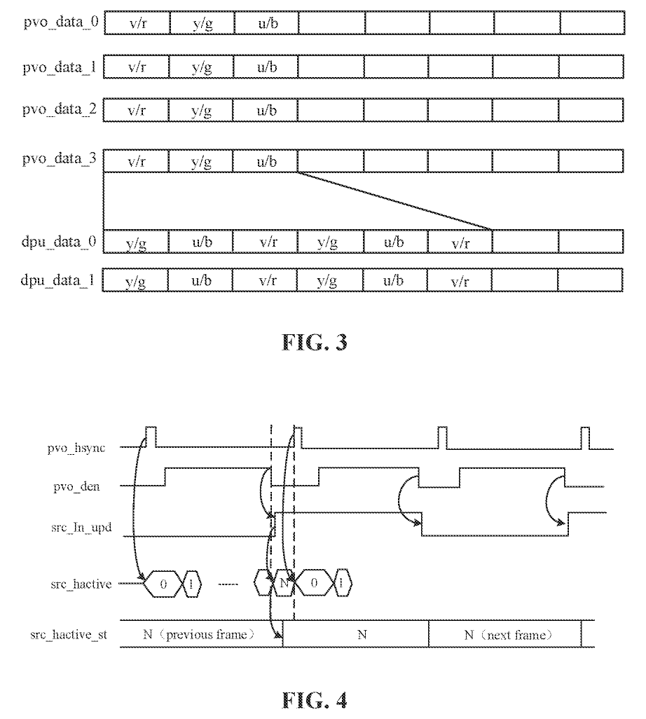

Based on the connection relationship shown in FIG. 2, the multimedia module interface transmits the first image signal to the write control unit 14. The first image signal corresponds to pvo_data_0/1/2/3 from the multimedia module interface to the write control unit 14 in FIG. 4. pvo indicates that the first image signal is transmitted based on the clock domain of the multimedia module interface. In some embodiments, the multimedia module interface also transmits an image enable signal to the write control unit 14. The image enable signal is used for indicating that writing of the received first image signal can be started and is denoted pvo_data_en_0/1/2/3 in FIG. 3.

In some embodiments, the write control unit 14 may determine the write address signal and the write enable signal according to the image enable signal after receiving the image enable signal output by the multimedia module interface. Taking the image enable signals including a pvo_data_en_0 signal, a pvo_data_en_1 signal, a pvo_data_en_2 signal, and a pvo_data_en_3 signal as an example, the process of determining the write address signal and the write enable signal according to the image enable signals includes performing an OR operation on the opvo_data_en_0 signal, the pvo_data_en_1 signal, the pvo_data_en_2 signal, and the pvo_data_en_3 signal, and the result of the OR operation is the register pvo_data_en signal and the write control unit 14 may use the register pvo_data_en signal as the write enable signal. Since the register pvo_data_en signal is obtained by the OR operation, the register pvo_data_en signal is a single-bit signal. In the case that the write enable signal is valid, the write control unit 14 counts through the clock of the multimedia module interface and acquires the pvo_addr as the write address signal. In some cases, the clock of the multimedia module interface may be referred to as hdmi_clk.

The write control unit 14 may output the write address signal, the write enable signal, and the first image signal to the storage unit 11 after determining the write address signal and the write enable signal. In some embodiments, the write control unit 14 may directly transmit the first image signal to the storage unit 11, or may process the first image signal. Taking the first image signal including the pvo_data_0 signal, the pvo_data_1 signal, the pvo_data_2 signal, and the pvo_data_3 signal as an example in FIG. 2, the write control unit 14 combines the pvo_data_0 signal, the pvo_data_1 signal, the pvo_data_2 signal, and the pvo_data_3 signal, and the obtained combination result is the register pvo_data signal, and the write control unit 14 transmits the register pvo_data signal to the storage unit 11 as the processed first image signal. Since the register pvo_data signal is a signal obtained by combining a plurality of signals, the register pvo_data signal is a multi-bit signal.

The storage unit 11, after receiving the write address signal, the write enable signal, and the first image signal, may write the first image signal according to the write address signal in the case that the write enable signal is valid. In FIG. 2, waddr corresponds to the write address signal, wdata corresponds to the first image signal, and w_en corresponds to the write enable signal. In some embodiments, the storage unit 11 determines the memory space corresponding to the first image signal according to the write address signal and stores the received first image signal in the determined memory space, thus writing the first image signal into the storage unit 11.

The interface conversion circuit further includes, like the write control unit 14, a read control unit 15, which is used for reading the first image signal from the storage unit 11. Referring to FIG. 2, the storage unit 11 is connected to the mapping unit 12 via the read control unit 15. The clock domain of the read control unit 15 is consistent with the clock domain of the display module interface. In some embodiments, the read control unit 15 acquires a clock domain enable signal of the interface conversion circuit to acquire a read enable signal, counts through the clock of the display module interface in the case that the read enable signal is valid, and determines the read address signal according to the counting result.

In some embodiments, the clock domain enable signal may be the clock domain enable signal output by the clock domain conversion unit 17 in FIG. 2, since the clock domain conversion unit 17 is used for converting the clock domain from the clock domain of the multimedia module interface to the clock domain of the display module interface. Therefore, the clock domain enable signal acquired by the read control unit 15 reflects the clock domain of the display module interface, which may, in some cases, be referred to as dpu_den as shown in FIG. 2. dpu functions similarly to pvo to indicate that the clock domain of the signal is the clock domain of the display module interface. For the detailed functions of the clock domain conversion unit 17, reference may be made to related description in the following embodiments, which are not repeated herein. Details are not repeated herein again.

The read control unit 15 uses the clock domain enable signal as the read enable signal r_en of the storage unit 11 after receiving the clock domain enable signal, and then counts through the clock of the display module interface, i.e., dpu_clk, to acquire dpu_addr in the case that the read enable signal is valid, and divides dpu_addr by 2 to acquire the read address signal raddr. The reason of dividing by 2 is that the clock of the display module interface is twice the clock of the multimedia module interface, and the dpu_addr counted based on the clock of the display module interface is twice the address signal used in the storage unit, and the read address signal is adjusted to the format readable by the storage unit 11 by dividing by 2.

The read control unit 15 transmits the read address signal and the read enable signal to the storage unit 11 after determining the read address signal and the read enable signal, and the storage unit 11, after receiving the read enable signal and the read address signal, reads out the first image signal according to the read address signal in the case that the read enable signal is valid and transmits the first image signal to the read control unit 15. In some embodiments, the storage unit 11 may search for and determine the storage space where the to-be-read first image signal is located according to the read address signal, access the determined storage space, read the first image signal in the storage space, and transmit the first image signal to the read control unit 15. For the transmitted first image signal, see rdata shown in FIG. 2. The r in the read-out first image signal rdata is used for distinguishing from the written-in first image signal wdata and is intended to distinguish different operations such as reading and writing with respect to the first image signal, but actually the read-out first image signal rdata and the written-in first image signal wdata are consistent.

In some embodiments, the read control unit 15 may transmit the first image signal to the mapping unit 12 after receiving the first image signal. In some embodiments, in the case that the write control unit 14 processes the first image signal during the transmission of the first image signal, the read control unit 15 may restore the processed first image signal during the transmission of the first image signal, for example, decomposing the pvo_data obtained by combination into pvo_data_0/1/2/3 and thereby restoring the first image signal output by the multimedia module interface, and then transmit the restored first image signal to the mapping unit 12. In some embodiments, the read control unit 15 also adjusts the mapping relationship and transmits it to the display module interface.

In some embodiments, after receiving the first image signal, the mapping unit 12 may reorder the pixel components of the first image signal to obtain a second image signal meeting the display requirement of the display module interface, thus transmitting the second image signal that can be processed to the display module interface. The format of the first image signal output by the multimedia module interface is 4 pixels/clk, and the format of the signal that can be received by the display module interface is 2 pixels/clk. Therefore, the mapping unit 12 reorders the pixel components of the first image signal.

FIG. 3 is a schematic diagram illustrating the effect of reordering according to some embodiments of the present disclosure. pvo_data_0, pvo_data_1, pvo_data_2, and pvo_data_3 in FIG. 3 are the first image signals, dpu_data_0 and dpu_data_1 are the second image signals after reordering, and the connection line between pvo_data_3 and dpu_data_0 in FIG. 3 is intended to indicate that dpu_data_0 and dpu_data_1 are obtained by processing based on pvo_data_0, pvo_data_1, pvo_data_2, and pvo_data_3.

The timing of the first image signal is 4 pixels/clk and the timing of the second image signal is 2 pixels/clk, that is, the amount of pixels output per unit clock is reduced, and the amount of pixels of the first image signal is twice the amount of pixels of the second image signal. In this case, the first image signal can be combined to obtain the second image signal. The v/r, y/g, and u/b in FIG. 3 indicate color components, and referring to FIG. 3, the first image signal includes three color components, and the color components of two first image signals are combined to obtain the second image signal including six color components. Through the cross-clock domain processing of 4 p to 2 p, the receive clock of the display module interface is improved to be twice that of the multimedia module interface.

Moreover, the mapping unit 12 also adjusts the color components YCRCB/RGB during reordering of the pixel components, such that the color components of the second image signal also meet the display requirement of the display module interface. In addition, the color components of the first image signal are reordered, but actually the data of the first image signal is not changed, that is, the data of the first image signal is the same as the data of the second image signal.

In some embodiments, since the display module interface also refers to the screen parameter during the process of refreshing the screen according to the second image signal, the interface conversion circuit may also provide the screen parameter required during the process of refreshing the second image signal to the display module interface.

Referring to FIG. 2, the interface conversion circuit further includes a synchronization unit 16 and a clock domain conversion unit 17. The synchronization unit 16 is connected to the multimedia module interface, the synchronization unit 16 is also connected to the clock domain conversion unit 17, and the clock domain conversion unit 17 is connected to the mapping unit 12. The synchronization unit 16 is configured to receive an inputting timing signal from the multimedia module interface and transmit the inputting timing signal to the clock domain conversion unit 17. The inputting timing signal is used for controlling the screen parameter in the process of displaying the image, and the inputting timing signal is within the clock domain of the multimedia module interface.

Exemplarily, the clock domain of the synchronization unit 16 is kept consistent with the clock domain of the multimedia module interface, and the clock domains of the synchronization unit 16 and the multimedia module interface are aligned to eliminate the metastability caused by multi-bit transmission. The metastability means that the level of a transmitted signal oscillates between a high level and a low level and thus the level of a signal received by a receiving end is a third stable point between the high level and the low level and the signal cannot be accurately read. In this case, the frequency of the multimedia module interface when outputting the inputting timing signal and the frequency of the synchronization unit 16 when receiving the inputting timing signal can be synchronized by clock domain alignment, thus avoiding the level oscillation of the inputting timing signal and improving the transmission accuracy of the inputting timing signal.

Therefore, the synchronization unit 16 also performs clock domain alignment before receiving the inputting timing signal. For example, the inputting timing signal includes vsync (Vertical Sync, vertical synchronization signal), and the vertical synchronization signal is used for identifying that all line scans of the current frame have been completed and the display of the next frame is ready to start. In some embodiments, the synchronization unit 16 may control the synchronization unit 16 to synchronize with the clock domain of the multimedia module interface according to the vertical synchronization signal.

In some embodiments, the synchronization unit 16 may refer to the configuration information update signal. In FIG. 2, the interface conversion circuit is further connected to a configuration module, and the configuration module may transmit register configuration parameters to the synchronization unit 16 to configure units in the interface conversion circuit. The register configuration parameters include, e.g., vsw, hsw, hbp, fdelay, vdelay, hdelay, sw_hactive, sw_force_en, cfg_upd, ipvo_format, and ipvo_type in FIG. 2. The ipvo_format and ipvo_type are used for indicating the format and the type of the first image signal from the multimedia module interface. The cfg_upd is a configuration information update signal and is used for indicating whether the configuration is valid; the currently performed configuration is valid in the case that the cfg_upd is enabled, and the currently performed configuration is invalid in the case that the cfg_upd is disabled. The cfg_upd may be enabled when asserted high. For example, in the case that the cfg_upd is made high, the cfg_upd is enabled, indicating that the currently performed configuration is valid; in the case that the cfg_upd is made low, the cfg_upd is disabled, indicating that the currently performed configuration is invalid. The cfg_upd may also be enabled when asserted low. For example, in the case that the cfg_upd is made low, the cfg_upd is enabled, indicating that the currently performed configuration is valid; in the case that the cfg_upd is made high, the cfg_upd is disabled, indicating that the currently performed configuration is invalid. This is not limited in the embodiments of the present disclosure.

In some embodiments, the synchronization unit 16 enables the configuration information update signal to indicate that configuration can be performed currently. In some embodiments, the process of configuring the synchronization unit 16 may be custom-controlled by software, or the default configuration may be retained by hardware. The synchronization unit 16 waits for the vertical synchronization signal output by the multimedia module interface to be enabled after completion of the configuration and completes the register synchronization in the case of the enabling. In some embodiments, for the synchronization unit 16, the enabling of the vertical synchronization signal may not occur. For example, the vertical synchronization signal is not enabled within a reference period. The reference period is any duration set based on experience and implementation environment. In this case, the synchronization unit 16 may disable the configuration information update signal, and in the case that the configuration information update signal is enabled again based on the vertical synchronization signal, it is determined that the clock domain of the synchronization unit 16 is synchronized with the clock domain of the multimedia module interface.

Exemplarily, the processes of enabling the configuration information update signal and enabling the vertical synchronization signal are similar to the description of enabling cfg_upd in the embodiment described above, and the enabling may be assert-high enabling or assert-low enabling. The synchronization process described above is illustrated below by taking the assert-high enabling as an example.

The synchronization unit 16 makes the configuration information update signal high to indicate that configuration can be performed currently and waits for the vertical synchronization signal output by the multimedia module interface to be made high after the configuration is completed, and the register synchronization is completed in the case that the vertical synchronization signal is made high. If the vertical synchronization signal is not made high within the reference period, the synchronization unit 16 may make the configuration information update signal low, and in the case that the configuration information update signal is made high again based on the vertical synchronization signal, it is determined that the clock domain of the synchronization unit 16 is synchronized with the clock domain of the multimedia module interface. Here, being made high again means that the configuration information update signal changes from 0 to 1 again after changing from 1 to 0. The configuration information update signal or the vertical synchronization signal is used as the switch for updating the synchronization of the register, and the precise timing for clock synchronization is determined based on the change of the switch, thereby solving the metastability caused by the cross-clock synchronization of the register.

In some embodiments, in the synchronization process described above, since there will be waiting for multiple clocks to enable the vertical synchronization signal or disable the configuration information update signal, the process of synchronizing the clock domains described above may be regarded as a static configuration. The synchronization unit 16 may also select a synchronized clock, for example, to sample with the synchronized clock of the display module interface or to use the synchronized configuration information.

No matter how the synchronization unit 16 synchronizes the clock domain with the clock domain of the multimedia module interface, it may receive the inputting timing signal from the multimedia module interface based on the synchronized clock domain and transmit the inputting timing signal to the clock domain conversion unit 17. The clock domain conversion unit 17 performs clock domain conversion to convert the inputting timing signal to obtain the outputting timing signal, and the outputting timing signal is within the clock domain of the display module interface. Referring to FIG. 2, the inputting timing signal includes a field signal, a row synchronization signal, a type signal, and a format signal in addition to the vertical synchronization signal. The field signal corresponds to pvo_field_0/1/2/3 in FIG. 2 and is used for controlling the number of fields displayed by the display module interface, and it indicates the start and end of a complete image. The type signal corresponds to pvo_type in FIG. 2; the format signal corresponds to pvo_format in FIG. 2; the row synchronization signal corresponds to hsync in FIG. 2 and is used for indicating the start and end of one line of pixel components.

In some embodiments, the clock domain conversion unit 17 further acquires a horizontal resolution signal and a register configuration parameter and converts the inputting timing signal, the register configuration parameter, and the horizontal resolution signal into the outputting timing signal. The horizontal resolution signal indicates the horizontal resolution of the clock domain of the multimedia module interface, and the register configuration parameter is the parameter used for configuring the interface conversion circuit. The outputting timing signal resulting from conversion includes the data enable signal dpu_data_en, the row synchronization signal dpu_hsync, the vertical synchronization signal dpu_vsync, and the field signal dpu_field that are within the clock domain of the display module interface. In the following illustration of the signal conversion process, the prefix pvo is used for signals within the clock domain of the multimedia module interface, the prefix sw is used for register configuration parameters, and the prefix dpu is used for signals within the clock domain of the display module interface. The process of converting the inputting timing signal to the outputting timing signal may also be referred to as a process of reconstructing timing.

In some embodiments, the horizontal resolution signal may be obtained by counting. Referring to the timing diagram in FIG. 4, the counter is cleared at the time of the rising edge of pvo_hsync, starts counting at the time of the rising edge of pvo_den, and stops counting at the time of the falling edge of pvo_den. Thereafter, in the case that pvo_hsync reaches the rising edge again, the counting of the next column is performed. In FIG. 4, src_In_upd is inverted at every falling edge of pvo_den, and each inversion represents an htotal (horizontal total pixels). After delaying src_In_upd by using five flip-flops, the rising edge or the falling edge of src_ln_upd is taken, and in this case, the register dst_ln_upd_tgl is made high. In the case that dst_ln_upd_tgl = 1, the horizontal resolution signal src_hactive that is read is synchronized to dpu clock domain, i.e., dpu_hactive.

For the dpu_vsync, dpu_hsync, dpu_den, and dpu_field timing included in the outputting timing signal, the clock domain conversion unit 17 uses register configuration parameters during the acquisition process. The register configuration parameters include sw_vsw (vertical synchronization signal), sw_hsw (row synchronization signal), sw_hbp (horizontal back-shoulder pulse signal), sw_hdelay (horizontal delay signal), sw_vdelay (vertical delay signal), sw_fdelay (frame delay signal), sw_hactive (horizontal active signal), and sw_force_en (forced enable signal).

In some embodiments, sw_vsw is the dpu_vsync width, sw_hsync is the dpu_hsync width, sw_hbp is the dpu_hblack length, sw_hdelay is the delay amount relative to pvo_hsync, sw_vsync is the delay amount relative to pvo_vsync, sw_fdelay is the delay amount of pvo_field, and sw_hactive is the software-configured hactive length. In the case that sw_force_en is high, it is indicated that the software-configured length of hactive is used and the output hactive amount of the clock domain of the multimedia module interface is not used. The process of determining the outputting timing signal based on the register configuration parameters and the inputting timing signal is illustrated hereinafter.

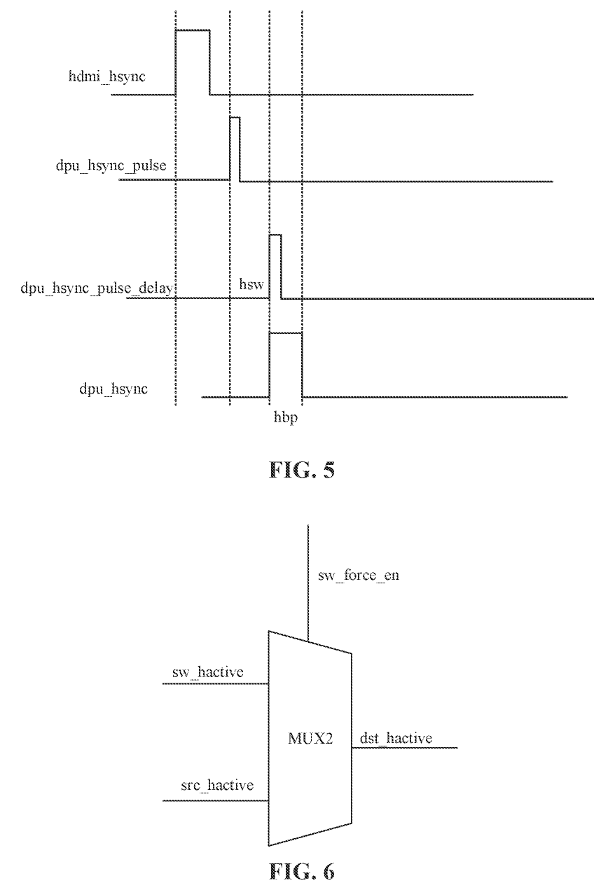

With respect to dpu_hsync, referring to FIG. 5, the clock domain conversion unit 17 enters the dpu clock domain, that is, the clock domain of the display module interface, through synchronization using two flip-flops, checks the rising edge of hdmi_hsync, that is, pvo_hsync in the embodiment described above, acquires dpu_hsync_pulse, and delays the pulse dpu_hsync_pulse by sw_hsw through the counter 1, and thus acquires dpu_hsync_pulse_delay. The width of the pulse dpu_hsync_pulse_delay is stretched to be dpu_sync by the counter 2, the counting is started in the case that dpu_hsync_pulse_delay is detected to be high, the signal dpu_hsync is made high until the count is hbp, and the signal dpu_hsync is then made low, thus obtaining dpu_hsync. In some embodiments, the sw_hsw and sw_hbp used are determined according to the actual hsync width and hblack width.

For the dpu_hactive, the clock domain conversion unit 17 synchronizes the 1-bit src_ln_upd signal by using five filp-flops, and the rising edge or the falling edge of the src_ln_upd signal after the delay is detected is src_ln_upd_pulse. After synchronization by using five flip-flops, pvo_hactive of the clock domain of the multimedia module interface can be considered static, and in this case, the dpu clock domain is synchronized by using a flip-flop, and whether to use the sw_hactive configured by the register as dpu_hactive or not can be determined by the configuration register. pvo_hactive corresponds to src_hactive in FIG. 6, and the configuration register corresponds to MUX2 in FIG. 6. MUX2 starts to select the dst_hactive serving as dpu_hactive according to src_hactive and sw_hactive in the case that sw_force_en is valid and outputs the selected dst_hactive to complete the clock domain conversion of hactive.

For dpu_den, in the case that the clock domain conversion unit 17 detects the falling edge of dpu_hsync, the counter 3 counts until hdelay (it is recommended that hdelay is greater than or equal to 1/2 htotal) is reached, dpu_den is made high, and then the counter 4 counts until dst_hactive is reached, and then dpu_den is made low, thus completing dpu_den generation in one row.

For dpu_vsync, since the scanning modes of a video include progressive (P) scan and interlaced (I) scan, and vsync and hsync under the two modes are different. Under the P mode, vsync and hsync are fully synchronized with rising edges aligned, while under the I mode, vsync and hsync have aligned rising edges for alternate lines. Therefore, the clock domain conversion unit 17 will also determine whether it is P mode or I mode and reconstruct dpu_vsync based on the result.

In some embodiments, in the case that this is a transition of pvo_field, it can be determined that the adopted scanning mode is I mode, since pvo_field is always 0 under P mode. In some embodiments, since misleading of the non-standard image signal cannot be excluded according to the transition of pvo_field, the clock domain conversion unit 17 may also determine the scanning mode by detecting whether the rising edges of pvo_vsync and pvo_hsync are synchronized. In the case that it is detected that the rising edges of pvo_vsync and pvo_hsync are not synchronized, the interlace_valid signal is made high and it is determined that the adopted scanning mode is I mode. In the case that they are synchronized, the interlace_valid signal is made low and it is determined that the adopted scanning mode is P mode. Exemplarily, after determining whether the adopted scanning mode is P mode or I mode, the clock domain conversion unit 17 may use a corresponding acquiring mode to acquire dpu_vsync according to the scanning mode.

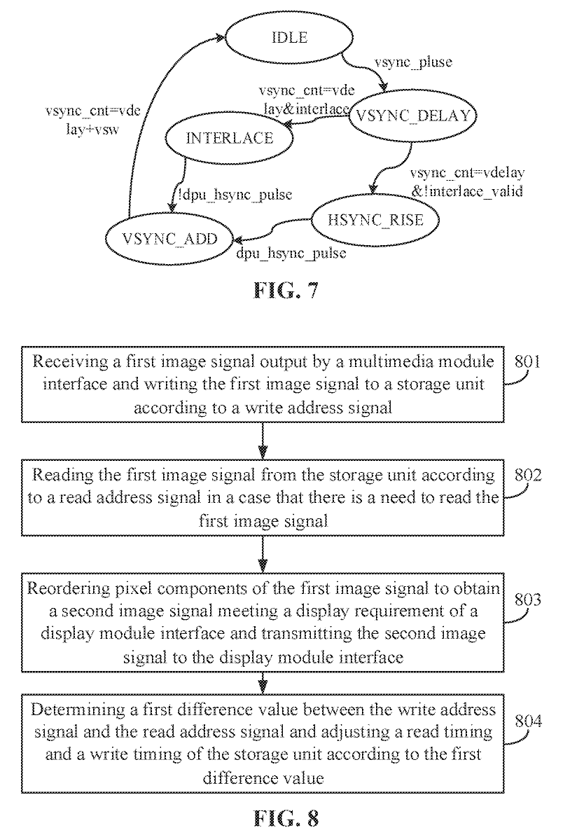

Since the P-mode is a case that vsync and hsync are completely synchronized, the clock domain conversion unit 17 can directly take the reconstructed dpu_hsync as dpu_vsync in the case that it is determined that the scanning mode is P mode. For the I mode where vsync and hsync have aligned rising edges for alternate lines, and every other line is not aligned, the clock domain conversion unit 17 may acquire dpu_vsync in the manner shown in FIG. 7 in the case that it is determined that the scanning mode is I mode.

In FIG. 7, the initial state is IDLE state. Under this state, the clock domain conversion unit 17 adjusts to enter the VSYNC_DELAY state in the case that it detects the rising edge of pvo_vsync of the clock domain of the multimedia module interface, i.e., pvo_vsync_pulse. The VSYNC_DELAY state is used for generating the delay of dpu_vsync. When entering the VSYNC_DELAY, the counter vsync_cnt starts counting. In some embodiments, the vsync number may be read by using the write control unit 14 as the counter, and the vsync number read may be transmitted to the clock domain conversion unit 17. In the case that vdelay is reached in counting and interlace_valid is low, there is a jump to HSYNC_RISE state; in the case that vdelay is reached in counting and interlace_valid is high, there is a jump to INTERLACE state.

In some embodiments, the HSYNC_RISE state is used for generating dpu_vsync synchronized with dpu_hsync in terms of rising edges. In the case that the rising edge of dpu_vsync is detected to be made high, i.e., dpu_hsync_pulse in FIG. 7, there is a jump to the VSYNC_ADD state. In this case, dpu_sync is made high to be 1.

In some embodiments, the VSYNC_ADD state is used for generating the width of dpu_vsync. In the case that the counter vsync_cnt counts to vdelay+vsw, the state machine jumps to the initial IDLE state, and in this case, dpu_vsync is made low to be 0. The counter vsync_cnt is cleared at each rising edge of s_pvo_vsync.

Exemplarily, the INTERLACE state is used for generating dpu_vsync out of sync with dpu_hsync in terms of rising edges and thus enabling the acquisition of dpu_vsync. In some embodiments, the clock domain conversion unit 17 also jumps to the VSYNC_ADD state in the case that it is detected in the INTERLACE state that the rising edge of dpu_hsync is not 0, i.e., not the rising edge of dpu_hsync.

Exemplarily, for dpu_field, the clock domain conversion unit 17 may delay fdelay delays within the dpu clock domain based on pvo_field for acquisition. Through the above operation, the clock domain conversion unit 17 converts the screen parameter adopted in the process of displaying the image by the multimedia module interface into the display parameter supported by the display module interface to obtain the outputting timing signal, and transmits the outputting timing signal to the display module interface, such that the display module interface can display the second image signal according to the screen parameter.

In some embodiments, based on the situation shown in FIG. 2 that the clock domain conversion unit 17 is connected to the display module interface via the mapping unit 12, the clock domain conversion unit 17 may transmit the outputting timing signal to the mapping unit 12, and the mapping unit 12 transmits the outputting timing signal to the display module interface after receiving the outputting timing signal.

In some embodiments, the display module interface displays the second image signal according to the screen parameter, that is, the display module interface displays images based on the outputting timing signal and the second image signal. In this case, the mapping unit 12 may synchronously transmit the outputting timing signal and the second image signal to the display module interface. For example, as shown in FIG. 2, the transmitted second image signals are dpu_data_yg/ub/vr, and the outputting timing signals are dpu_field, dpu_den, dpu_vsync, and dpu_hsync.

In some embodiments, the interface conversion circuit performs deviation detection in addition to conversion of the first image signal and the inputting timing signal based on the above-described units. For example, as shown in FIG. 1 and FIG. 2, the interface conversion circuit includes a deviation detection unit 13. The deviation detection unit 13 is configured to acquire a write address signal and a read address signal, determine a first difference value between the write address signal and the read address signal, and adjust the read timing and the write timing of the storage unit 11 according to the first difference value, thus correcting jitter accumulation caused by non-homologous clock domains, repairing pixel shift caused by jitter accumulation, and improving the quality of images displayed based on the second image signal.

In some embodiments, the deviation detection unit 13 is configured to synchronize deviation detection to acquire the read address signal and the write address signal respectively at two sides of the storage unit 11. For example, as shown in FIG. 2, the write address signal waddr on the address line is read in the process that the write control unit 14 inputs the write address signal to the storage unit 11 through the address line, and the read address signal raddr on the address line is read in the process that the read control unit 15 inputs the read address signal to the storage unit 11 through the address line.

In some embodiments, the read address signal and the write address signal are not in the same clock domain. For example, the clock domain where the read address signal is located is the clock domain of the display module interface, and the clock domain where the write address signal is located is the clock domain of the multimedia module interface. Therefore, the deviation detection unit 13 performs clock domain alignment on the read address signal and the write address signal, for example, synchronizes the write address signal to the clock domain of the display module interface where the read address signal is located. In some embodiments, the deviation detection unit 13 may use gray code synchronization to implement clock domain alignment of the read address signal and the write address signal, and the deviation detection unit 13 may also use other multi-bit synchronization modes.

After the clock domain alignment, the deviation detection unit 13 subtracts the read address signal from the write address signal to obtain a first difference value and detects according to the first difference value. For example, in the case that the first difference value is not less than the unit depth of the storage unit 11, it is determined that the detection result indicates that the clock domain of the display module interface is slow; or, in the case that the first difference value is less than a first numerical value, it is determined that the detection result indicates that the clock domain of the display module interface of the storage unit 11 is fast.

The first difference value can be represented by waddr-raddr. The unit depth indicates the depth of the storage cell 11 and is used for reflecting the size of the data volume that the storage unit 11 can store at most, that is, the storage capacity of the storage unit 11, and it can be represented by depth_sram. The first numerical value may be 0 set based on experience, or may be any numerical value that can determine whether the storage unit 11 is empty.

Since waddr indicates the position where the first image signal written into the storage unit 11 is located and raddr indicates the position where the first image signal read from the storage unit 11 is located, in the case that waddr-raddr ≥ depth_sram, that is, the first difference value is not less than the unit depth, it means that the first image signal written into the storage unit 11 is greater than or equal to the first image signal read from the storage unit 11 and the unit depth, that is, the storage unit 11 is full and there is a risk of overflow. Based on this, the deviation detection unit 13 makes hdmi2dpu_sync_error bit0 high and reports a sram overflow error.

Exemplarily, in the case that waddr-raddr ≤ 0, it means that the first image signal written into the storage unit 11 is less than or equal to the first image signal read from the storage unit 11, and the storage unit 11 is completely empty. In this case, the deviation detection unit 13 makes hdmi2dpu_sync_error bit1 high and reports a sram underoverflow error.

After the deviation detection unit 13 detects a problem, it may continue to correct the error. In the case that hdmi2dpu_sync_error bit0 is made high and an overflow is indicated, it means that the reading speed of reading the first image signal from the storage unit 11 is slow, the speed of reading the first image signal is lower than the speed of writing the first image signal, and the first image signal written in the storage unit 11 is not read in time, thereby causing overflow in the storage unit 11.

In addition, since the reading speed of reading the first image signal from the storage unit 11 is controlled by clk of the display module interface, the reading speed being slow means that the clock domain of the display module interface is slow. The reason why the clock domain is slow may be that there is an abnormity in the timing constructed by the clock domain conversion unit 17 during the clk configuration of the display module interface. The constructed timing is the timing required by the display module interface for configuring the clk of the display module interface, and in some cases, the constructed timing may also be called reconstructed timing. The reason why the clock domain is slow may also be that the quality of the reference module for configuring clk has problems. For example, although there is no abnormity in timing constructed by the clock domain conversion unit 17, the quality of the reference module is poor and it is not possible to strictly configure, based on timing, clk of the display module interface to be twice that of the multimedia module interface. No matter the timing is abnormal or the quality of the reference module is in problem, whether the clk of the display module interface is twice that of the multimedia module interface can be detected, and if not, the clock domain of the display module interface is adjusted by adjusting parameters such as sw_vsw, sw_hsw, and sw_hbp in the register configuration parameters.

For the case that hdmi2dpu_sync_error bit1 is made high and underflow is present, the deviation detection unit 13 determines that the reading speed of the interface end of the display module is fast. Similar to the reason of slow reading speed, the reason of fast reading speed is also that the clock domain of the display module interface is fast. The deviation detection unit 13 may detect whether the clk of the display module interface is twice that of the multimedia module interface, and if not, the parameters such as sw_vsw, sw_hsw, and sw_hbp can be adjusted to reduce the clock domain of the display module interface, thus realizing error repairing and clearing the error.

In some embodiments, the error repairing process may be performed by the deviation detection unit 13, or may be performed by other modules. For example, as shown in FIG. 2, the deviation detection unit 13 transmits hdmi2dpu_sync_error to the configuration module; the hdmi2dpu_sync_error includes hdmi2dpu_sync_error bit1 and hdmi2dpu_sync_error bit0 in the embodiment described above. The configuration module detects and repairs the configuration parameters of the interface conversion circuit according to the hdmi2dpu_sync_error. After the repair is finished, hdmi2dpu_sync_clr is made high to indicate that the error is successfully repaired, and the reported error is cleared.

It should be noted that the above examples are intended to illustrate the interaction process of the units included in the interface conversion circuit and are not used for limiting the shape, configuration position, name, and the like of each unit in the interface conversion circuit. In some cases, in FIG. 2, the synchronization unit 16 may be referred to as HDMI_SYNC, the clock domain conversion unit 17 may be referred to as RETIMG, the mapping unit 12 may be referred to as MAPPING, the write control unit 14 may be referred to as MEM_WR_CTRL, the storage unit 11 may be referred to as SRAM, the read control unit 15 may be referred to as MEM_RD_CTRL, and the deviation detection unit 13 may be referred to as SYNC_ERR_DETE. Also, similar to the description of enabling cfg_upd, the signals being made high or low described in the above embodiments is intended to illustrate a possible manner of enabling or disabling and is not intended to limit the manner of enabling or disabling. For example, the hdmi2dpu_sync_error bit0 being made high in the above embodiment is intended to illustrate a possible way of enabling the hdmi2dpu_sync_error bit0, and in some cases, the hdmi2dpu_sync_error bit0 may also be enabled by making hdmi2dpu_sync_error bit0 low.

In summary, the interface conversion circuit provided in the embodiments of the present disclosure converts the 4-pixel first image signal output by the multimedia module interface into the 2-pixel second image signal required by the display module interface by reordering the pixel components, so as to meet the display requirement of the display module interface, which ensures that the timing of the multimedia module interface and that of the display module interface are matched and allows for more accurate display of images. The deviation detection unit 13 determines, according to the write address signal and the read address signal, whether the storage unit 11 is in a completely full or empty state caused by frequency offset accumulation, corrects reading and writing time, and performs frequency offset correction for every row, thereby avoiding the situation that the storage unit 11 is extremely full, avoiding the playback stuttering or frame loss caused by the loss of pixel components, and ensuring the display quality. Considering the non-standard video format, dpu_vsync can be reconstructed in different ways based on different scanning manners, and thus high flexibility and wide universality are provided.

The embodiments of the present disclosure further provide a method for processing signals. The method for processing signals may be executed by the interface conversion circuit shown in FIG. 1 or FIG. 2, and the flowchart of the method is shown in FIG. 8 and includes steps 801-804.

In step 801, a first image signal output by a multimedia module interface is received and written in according to a write address signal.

In some embodiments, the process of receiving and writing the first image signal by the interface conversion circuit includes: receiving a first image signal and an image enable signal output by a multimedia module interface and determining a write address signal and a write enable signal according to the image enable signal; and writing the first image signal to a storage unit according to the write address signal in the case that the write enable signal is valid.

Exemplarily, the interface conversion circuit includes a storage unit, a mapping unit, and a deviation detection unit. The storage unit is connected to the multimedia module interface, the mapping unit, and the deviation detection unit, and the mapping unit is connected to a display module interface. For the description of the structure of the interface conversion circuit, reference may be made to the description of the structure of the interface conversion circuit shown in FIG. 1 and FIG. 2, and the description thereof will not be repeated here. Since the interface conversion circuit includes the storage unit, the interface conversion circuit may receive and write the first image signal through the storage unit.

Exemplarily, the interface conversion circuit further includes a write control unit, and the storage unit is connected to the multimedia module interface via the write control unit. In this case, the writing the first image signal described above includes but is not limited to: receiving the first image signal and the image enable signal output by the multimedia module interface via the write control unit, determining the write address signal and the write enable signal according to the image enable signal, and outputting the write address signal, the write enable signal and the first image signal to the storage unit; and receiving, by the storage unit, the write address signal, the write enable signal, and the first image signal, and writing the first image signal to a storage unit according to the write address signal in the case that the write enable signal is valid.

The clock domain of the write control unit is consistent with the clock domain of the multimedia module interface, and the consistency in clock domain eliminates the metastability caused by the cross-module transmission of the first image signal and the image enable signal from the multimedia module interface to the write control unit, ensuring the accuracy of signal transmission. For details of writing the first image signal into the storage unit via the write control unit, reference may be made to the details about the write control unit 14’s writing the first image signal into the storage unit 11 in the embodiment shown in FIG. 2, and the description thereof will not be repeated here.

In step 802, in the case that there is a need to read the first image signal, the first image signal is read according to the read address signal.

Exemplarily, for the description about the existence of the need to read the first image signal, reference may be made to the description of reading the first image signal from the storage unit 11 in the embodiment shown in FIG. 2 described above. In some embodiments, the process of reading the first image signal includes: acquiring a clock domain enable signal and determining the clock domain enable signal as a read enable signal; counting through the clock of the display module interface in the case that the read enable signal is valid and determining the read address signal according to the counting result; and Reading the first image signal from the storage unit according to the read address signal.

In some embodiments, the interface conversion circuit further includes a read control unit. The storage unit is connected to the mapping unit via the read control unit, and the clock domain of the read control unit is consistent with the clock domain of the display module interface. The interface conversion circuit may read the first image signal from the storage unit via the read control unit, and the reading process includes, but is not limited to: acquiring the clock domain enable signal of the interface conversion circuit via the read control unit to obtain a read enable signal, counting through the clock of the display module interface in the case that the read enable signal is valid, determining the read address signal according to the counting result, and outputting the read enable signal and the read address signal to the storage unit; receiving the read enable signal and the read address signal through the storage unit, Reading the first image signal from the storage unit according to the read address signal in the case that the read enable signal is valid, and transmitting the first image signal to the read control unit; and receiving the first image signal by the read control unit. In some embodiments, for the interaction process of the read control unit and the storage unit, reference may be made to the interaction of the read control unit 15 and the storage unit 11 in the embodiment shown in FIG. 2, and the description thereof is not repeated here.

In step 803, the pixel components of the first image signal are reordered to obtain a second image signal meeting the display requirement of the display module interface, and the second image signal is transmitted to the display module interface.

In some embodiments, the interface conversion circuit may reorder the pixel components through the mapping unit. For example, the first image signal is received through the mapping unit, the pixel components of the first image signal are reordered to obtain the second image signal meeting the display requirement of the display module interface, and the second image signal is transmitted to the display module interface. Based on the situation that the interface conversion circuit reads out the first image signal from the storage unit via the read control unit in step 802, the first image signal may be transmitted to the mapping unit via the read control unit, such that the mapping unit acquires the first image signal and reorders the pixel components of the first image signal.

Exemplarily, for the process of reordering the pixel components of the first image signal by the mapping unit to obtain the second image signal, reference may be made to the process of reordering the pixel components of the first image signal by the mapping unit 12 to obtain the second image signal in the embodiment shown in FIG. 2, and the description thereof will not be repeated here. In some embodiments, since the display module interface also refers to the screen parameter during the scan display according to the second image signal, the interface conversion circuit may also provide the screen parameter to the display module interface to control the process of the scan display of the second image signal.

In some embodiments, the interface conversion circuit receives an inputting timing signal from the multimedia module interface. The inputting timing signal is used for controlling the screen parameter in the process of displaying the image, and the inputting timing signal is within the clock domain of the multimedia module interface; the inputting timing signal is converted to obtain an outputting timing signal, and the outputting timing signal is within the clock domain of the display module interface; the outputting timing signal is transmitted to the display module interface, and the outputting timing signal is used for controlling the display module interface to display an image according to the second image signal.

In some embodiments, the interface conversion circuit further includes a synchronization unit and a clock domain conversion unit. The synchronization unit is connected to the multimedia module interface, the synchronization unit is also connected to the clock domain conversion unit, the clock domain conversion unit is connected to the mapping unit, and the clock domain of the synchronization unit is consistent with the clock domain of the multimedia module interface. The interaction process of the synchronization unit, the clock domain conversion unit, and the mapping unit includes, but is not limited to: receiving the inputting timing signal from the multimedia module interface through the synchronization unit, and transmitting the inputting timing signal to the clock domain conversion unit; receiving the inputting timing signal through the clock domain conversion unit, converting the inputting timing signal to obtain an outputting timing signal, and transmitting the outputting timing signal to the mapping unit; and receiving the outputting timing signal through the mapping unit, and transmitting the outputting timing signal to the display module interface.

Similar to the process of receiving the first image signal, the interface conversion circuit synchronizes the clock domain before receiving the inputting timing signal, and exemplarily, it may synchronize the clock domain with the multimedia module interface according to the vertical synchronization signal. For the case that the inputting timing signal includes the vertical synchronization signal, the synchronization process includes, but is not limited to: enabling the configuration information update signal and determining, in case that the vertical synchronization signal is enabled, that the configuration information update signal is synchronized with the clock domain of the multimedia module interface, or enabling the configuration information update signal, disabling the configuration information update signal in case that the vertical synchronization signal is not enabled within the reference period, determining that the configuration information update signal is synchronized with the clock domain of the multimedia module interface in case that the configuration information update signal is enabled again based on the vertical synchronization signal.

In some embodiments, for the case that the synchronization unit receives the inputting timing signal in the above embodiment, the clock domain synchronization process described above may be to keep clocks of the synchronization unit and the multimedia module interface synchronized. The assert-high enabling is taken as an example below to illustrate how the synchronization unit synchronizes the clock domains. The configuration information update signal is made high through the synchronization unit, and it is determined that the clock domain of the synchronization unit is synchronized with the clock domain of the multimedia module interface in the case that the vertical synchronization signal is made high; or, the configuration information update signal is made high, the configuration information update signal is made low in the case that the vertical synchronization signal is not made high within the reference period, and it is determined that the clock domain of the synchronization unit is synchronized with the clock domain of the multimedia module interface in the case that the configuration information update signal is made high again based on the vertical synchronization signal.

The process for the synchronization unit to synchronize the clock domains according to the vertical synchronization signal is similar to the process for the synchronization unit 16 to synchronize the clock domains according to the vertical synchronization signal shown in FIG. 2. In addition, after the synchronization of the clock domains, the synchronization unit may receive the inputting timing signal from the multimedia module interface and transmit the received inputting timing signal to the clock domain conversion unit. The process of receiving and transmitting the inputting timing signal described above is similar to the process of receiving the inputting timing signal by the synchronization unit 16 and transmitting the inputting timing signal to the clock domain conversion unit 17 shown in FIG. 2, and reference may be made to the related description of FIG. 2, and the description thereof will not be repeated here.

The clock domain conversion unit may convert the clock domain of the inputting timing signal after receiving the inputting timing signal. Exemplarily, the clock domain conversion unit acquires a horizontal resolution signal and a register configuration parameter, and the horizontal resolution signal indicates the horizontal resolution of the clock domain of the multimedia module interface; the clock domain conversion unit converts the inputting timing signal, the register configuration parameter, and the horizontal resolution signal into the outputting timing signal. For the description of the clock domain conversion unit’s converting the inputting timing signal to obtain the outputting timing signal, reference may be made to the description of the clock domain conversion unit 17’s converting the inputting timing signal to obtain the outputting timing signal in the embodiment shown in FIG. 2, and the description thereof is not repeated here.

In some embodiments, the mapping unit may transmit the outputting timing signal to the display module interface after receiving the outputting timing signal. For example, the outputting timing signal and the second image signal are synchronously transmitted to the display module interface. The outputting timing signal and the second image signal can be from using different data lines.

In step 804, a first difference value between the write address signal and the read address signal is determined, and the read timing and the write timing is adjusted according to the first difference value.

In some embodiments, the interface conversion circuit may adjust the read timing and the write timing through the deviation detection unit. For example, through the deviation detection unit, the write address signal and the read address signal are obtained, the first difference value between the write address signal and the read address signal is determined, and the read timing and the write timing of the storage unit is adjusted according to the first difference value.

Exemplarily, since the clock domain corresponding to the read address signal is consistent with the clock domain of the display module interface, the deviation detection unit may detect the clock domain of the display module interface according to the first difference value and adjust the clock domain of the display module interface according to the detection result. The adjustment process includes, but is not limited to: in the case that the first difference value is not less than the unit depth, it is determined that the detection result indicates that the clock domain of the display module interface is slow; or, in the case that the first difference value is less than a first numerical value, it is determined that the detection result indicates that the clock domain of the display module interface is fast.

The clock domain of the display module interface is used for controlling the reading speed of the storage unit. The reading speed refers to the speed for the display module interface to read the first image signal from the storage unit, and the unit depth refers to the depth of the storage unit, i.e., the storage capacity of the storage unit. For the detailed process of adjusting the read timing and the write timing of the storage unit according to the deviation detection unit, reference may be made to the detailed process of adjusting the read timing and the write timing of the storage unit according to the deviation detection unit 13 in the embodiment shown in FIG. 2, and the description thereof will not be repeated here.

In summary, the method for processing signals provided in the embodiments of the present disclosure converts the 4-pixel first image signal output by the multimedia module interface into the 2-pixel second image signal required by the display module interface by reordering the pixel components, so as to meet the display requirement of the display module interface, which ensures that the timing of the multimedia module interface and that of the display module interface are matched and allows for more accurate display of images. According to the write address signal and the read address signal, it is determined whether the storage unit is in a completely full or empty state caused by frequency offset accumulation, the reading and writing are corrected in time, and the frequency offset correction is performed for every row, thereby avoiding the loss of pixel components caused by the storage unit’s being extremely full, effectively reducing the playback stuttering or frame loss caused by the loss of pixel components, and ensuring the display quality. Considering the non-standard video format, dpu_vsync can be reconstructed in different ways based on different scanning manners, and thus high flexibility and wide universality are provided.

The embodiments of the present disclosure provide an electronic device. The electronic device includes a multimedia module interface, an interface conversion circuit shown in FIG. 1 or FIG. 2, and a display module interface, and the interface conversion circuit is configured to execute the method for processing signals shown in FIG. 8.

Exemplarily, the electronic device may be any device having a display function and may be any terminal. In some embodiments, the terminal may be any electronic product capable of performing human-computer interaction with a user through one or more modes such as a keyboard, a touch pad, a touch screen, a remote controller, a voice interaction or handwriting device, and the like, for example, a PC (Personal Computer), a mobile phone, a smart phone, a PDA (Personal Digital Assistant), a wearable device, a PPC (Pocket PC), a tablet computer, a smart car machine, a smart television, or the like.

The embodiments of the present disclosure further provide an electronic device that is specifically implemented as a chip. An interface conversion circuit is formed inside the chip, and the interface conversion circuit is connected to the multimedia module interface and the display module interface and is configured to execute the method for processing signals shown in FIG. 8.

It should be noted that the information (including but not limited to user device information, user personal information, and the like.), data (including but not limited to data for analysis, stored data, displayed data, and the like.) and signals, which are referred to in the present disclosure, are authorized by the user or fully authorized by various parties, and the collection, use, and processing of the relevant data are required to comply with relevant laws and regulations and standards in relevant countries and regions. For example, the first image signals involved in the present disclosure are all acquired under sufficient authorization.

It should be understood that the term “a plurality of” herein means two or more. The term “and/or” describes the association relationship between the associated objects and indicates that three relationships may be present. For example, A and/or B may indicate that: only A is present, both A and B are present, and only B is present. The symbol “/” generally indicates an “or” relationship between the associated objects.

What is described above are merely exemplary embodiments of the present disclosure and are not intended to limit the present disclosure. Any modifications, equivalents, improvements, or the like, made within the principle of the present disclosure should fall within the protection scope of the present disclosure.

What is claimed is:

1. An interface conversion circuit, comprising a storage unit, a mapping unit, and a deviation detection unit, the storage unit being respectively connected to the mapping unit and the deviation detection unit, the storage unit being configured to be connected with a multimedia module interface for inputting a to-be-converted first image signal, and the mapping unit being configured to be connected with a display module interface for outputting a second image signal obtained by converting the first image signal,
wherein the storage unit is configured to receive the first image signal input from the multimedia module interface, write the first image signal into the storage unit according to a write address signal, and read the first image signal from the storage unit according to a read address signal;
wherein the mapping unit is configured to receive the first image signal read from the storage unit, reorder pixel components of the first image signal to obtain the second image signal meeting a display requirement of the display module interface, and transmit the second image signal to the display module interface; and
wherein the deviation detection unit is configured to acquire the write address signal and the read address signal, determine a first difference value between the write address signal and the read address signal, and adjust a read timing and a write timing of the storage unit according to the first difference value.

2. The interface conversion circuit according to claim 1, further comprising a write control unit, the storage unit being connected to the multimedia module interface via the write control unit, wherein
a clock domain of the write control unit is consistent with a clock domain of the multimedia module interface;
the write control unit is configured to receive the first image signal and an image enable signal which are output by the multimedia module interface, determine the write address signal and a write enable signal according to the image enable signal, and output the write address signal, the write enable signal, and the first image signal to the storage unit; and
the storage unit is configured to receive the write address signal, the write enable signal, and the first image signal and write the first image signal into the storage unit according to the write address signal in a case that the write enable signal is valid.

3. The interface conversion circuit according to claim 1, further comprising a read control unit, the storage unit being respectively connected to the mapping unit via the read control unit, wherein
a clock domain of the read control unit is consistent with a clock domain of the display module interface;
the read control unit is configured to acquire a clock domain enable signal of the interface conversion circuit and thereby obtain a read enable signal, count through a clock of the display module interface in a case that the read enable signal is valid, determine the read address signal according to a counting result, and output the read enable signal and the read address signal to the storage unit;
the storage unit is configured to receive the read enable signal and the read address signal, read the first image signal from the storage unit according to the read address signal in a case that the read enable signal is valid, and transmit the first image signal to the read control unit; and
the read control unit is configured to receive the first image signal and transmit the first image signal to the mapping unit.

4. The interface conversion circuit according to claim 1, wherein a clock domain corresponding to the read address signal is consistent with a clock domain of the display module interface, and the deviation detection unit is configured to detect the clock domain of the display module interface according to the first difference value and adjust the clock domain of the display module interface according to a detection result.

5. The interface conversion circuit according to claim 1, further comprising a synchronization unit and a clock domain conversion unit, the synchronization unit being connected to the multimedia module interface, the synchronization unit being further connected to the clock domain conversion unit, and the clock domain conversion unit being connected to the mapping unit, wherein
the synchronization unit is configured to receive an inputting timing signal from the multimedia module interface and transmit the inputting timing signal to the clock domain conversion unit, wherein the inputting timing signal is used for controlling a screen parameter in a process of displaying an image, the inputting timing signal is within a clock domain of the multimedia module interface, and a clock domain of the synchronization unit is consistent with the clock domain of the multimedia module interface;
the clock domain conversion unit is configured to receive the inputting timing signal, convert the inputting timing signal to obtain an outputting timing signal within a clock domain of the display module interface, and transmit the outputting timing signal to the mapping unit; and
the mapping unit is further configured to receive the outputting timing signal and transmit the outputting timing signal to the display module interface, wherein the outputting timing signal is used for controlling the display module interface to display an image according to the second image signal.

6. The interface conversion circuit according to claim 5, wherein the inputting timing signal comprises a vertical synchronization signal, and the synchronization unit is further configured to control the clock domain of the synchronization unit to be synchronized with the clock domain of the multimedia module interface according to the vertical synchronization signal.

7. The interface conversion circuit according to claim 6, wherein the synchronization unit is configured to: enable a configuration information update signal and determine, in a case that the vertical synchronization signal is enabled, that the clock domain of the synchronization unit is synchronized with the clock domain of the multimedia module interface; or
enable a configuration information update signal, disable the configuration information update signal in a case that the vertical synchronization signal is not enabled within a reference period, and determine that the clock domain of the synchronization unit is synchronized with the clock domain of the multimedia module interface in a case that the configuration information update signal is enabled again based on the vertical synchronization signal.

8. The interface conversion circuit according to claim 5, wherein the clock domain conversion unit is configured to acquire a horizontal resolution signal and a register configuration parameter and convert the inputting timing signal, the register configuration parameter, and the horizontal resolution signal into the outputting timing signal, wherein the horizontal resolution signal indicates a horizontal resolution of the clock domain of the multimedia module interface.

9. A method for processing signals, comprising:
receiving a first image signal output by a multimedia module interface and writing the first image signal to a storage unit according to a write address signal;
reading the first image signal from the storage unit according to a read address signal in a case that there is a need to read the first image signal;
reordering pixel components of the first image signal to obtain a second image signal meeting a display requirement of a display module interface and transmitting the second image signal to the display module interface; and
determining a first difference value between the write address signal and the read address signal and adjusting a read timing and a write timing of the storage unit according to the first difference value.

10. The method according to claim 9, wherein receiving the first image signal output by the multimedia module interface and writing the first image signal to the storage unit according to the write address signal comprises:
receiving the first image signal and an image enable signal which are output by the multimedia module interface and determining the write address signal and a write enable signal according to the image enable signal; and
writing the first image signal to the storage unit according to the write address signal in a case that the write enable signal is valid.

11. The method according to claim 9, wherein reading the first image signal from the storage unit according to the read address signal comprises:
acquiring a clock domain enable signal and determining the clock domain enable signal as a read enable signal;
counting through a clock of the display module interface in a case that the read enable signal is valid and determining the read address signal according to a counting result; and
reading the first image signal from the storage unit according to the read address signal.

12. The method according to claim 9, wherein adjusting the read timing and the write timing of the storage unit according to the first difference value comprises:
detecting a clock domain of the display module interface according to the first difference value; and
adjusting the clock domain of the display module interface according to a detection result.

13. The method according to claim 9, further comprising:
receiving an inputting timing signal from the multimedia module interface, wherein the inputting timing signal is used for controlling a screen parameter in a process of displaying an image, and the inputting timing signal is within a clock domain of the multimedia module interface;
converting the inputting timing signal to obtain an outputting timing signal, wherein the outputting timing signal is within a clock domain of the display module interface; and
transmitting the outputting timing signal to the display module interface, wherein the outputting timing signal is used for controlling the display module interface to display an image according to the second image signal.

14. The method according to claim 13, wherein the inputting timing signal comprises a vertical synchronization signal, and before receiving the inputting timing signal from the multimedia module interface, the method further comprises:
synchronizing, by a synchronization unit, a clock domain of the synchronization unit with the clock domain of the multimedia module interface according to the vertical synchronization signal.

15. The method according to claim 14, wherein synchronizing, by the synchronization unit, the clock domain of the synchronization unit with the clock domain of the multimedia module interface according to the vertical synchronization signal comprises:
enabling, by the synchronization unit, a configuration information update signal and determining, in a case that the vertical synchronization signal is enabled, that the configuration information update signal is synchronized with the clock domain of the multimedia module interface; or
enabling, by the synchronization unit, the configuration information update signal, disabling the configuration information update signal in a case that the vertical synchronization signal is not enabled within a reference period, and determining that the configuration information update signal is synchronized with the clock domain of the multimedia module interface in a case that the configuration information update signal is enabled again based on the vertical synchronization signal.

16. The method according to claim 13, wherein converting the inputting timing signal to obtain the outputting timing signal comprises:
acquiring a horizontal resolution signal and a register configuration parameter, wherein the horizontal resolution signal indicates a horizontal resolution of the clock domain of the multimedia module interface; and
converting the inputting timing signal, the register configuration parameter, and the horizontal resolution signal into the outputting timing signal.

17. An electronic device, comprising a multimedia module interface, an interface conversion circuit, and a display module interface, the interface conversion circuit comprising a storage unit, a mapping unit, and a deviation detection unit, the storage unit being respectively connected to the multimedia module interface, the mapping unit, and the deviation detection unit, and the mapping unit being connected to the display module interface,
wherein the storage unit is configured to receive a first image signal input from the multimedia module interface, write the first image signal into the storage unit according to a write address signal, and read the first image signal from the storage unit according to a read address signal;
wherein the mapping unit is configured to receive the first image signal read from the storage unit, reorder pixel components of the first image signal to obtain a second image signal meeting a display requirement of the display module interface, and transmit the second image signal to the display module interface; and
wherein the deviation detection unit is configured to acquire the write address signal and the read address signal, determine a first difference value between the write address signal and the read address signal, and adjust a read timing and a write timing of the storage unit according to the first difference value.

18. The electronic device according to claim 17, wherein the interface conversion circuit further comprises a write control unit, and the storage unit is configured to be connected to the multimedia module interface via the write control unit;
a clock domain of the write control unit is consistent with a clock domain of the multimedia module interface;
the write control unit is configured to receive the first image signal and an image enable signal output by the multimedia module interface, determine the write address signal and a write enable signal according to the image enable signal, and output the write address signal, the write enable signal, and the first image signal to the storage unit; and
the storage unit is configured to receive the write address signal, the write enable signal, and the first image signal and write the first image signal according to the write address signal in a case that the write enable signal is valid.

19. The electronic device according to claim 17, wherein the interface conversion circuit further comprises a read control unit, and the storage unit is configured to be connected to the mapping unit via the read control unit;
a clock domain of the read control unit is consistent with a clock domain of the display module interface;
the read control unit is configured to acquire a clock domain enable signal of the interface conversion circuit and thereby obtain a read enable signal, count through a clock of the display module interface in a case that the read enable signal is valid, determine the read address signal according to a counting result, and output the read enable signal and the read address signal to the storage unit;
the storage unit is configured to receive the read enable signal and the read address signal, read the first image signal according to the read address signal in a case that the read enable signal is valid, and transmit the first image signal to the read control unit; and
the read control unit is configured to receive the first image signal and transmit the first image signal to the mapping unit.

20. The electronic device according to claim 17, wherein a clock domain corresponding to the read address signal is consistent with a clock domain of the display module interface, and the deviation detection unit is configured to detect the clock domain of the display module interface according to the first difference value and adjust the clock domain of the display module interface according to a detection result.
